(19) United States
(12) Patent Application Publication
(10) Pub. No.: US 2024/0370062 A1
(43) Pub. Date: Nov. 7, 2024

(54) Foldable Electronic Device

(71) Applicant: Ticona LLC, Florence, KY (US)

(72) Inventor: Young Shin Kim, Cincinnati, OH (US)

(21) Appl. No.: 18/638,749

(22) Filed: Apr. 18, 2024

Related U.S. Application Data
(60) Provisional application No. 63/499,718, filed on May 3, 2023.

(51) Int. Cl. G06F 1/16

(52) U.S. Cl. CPC G06F 1/1681; G06F 1/1652

(57) ABSTRACT

A foldable electronic device comprising a housing that contains a first housing portion positioned on a first side of a bend axis and a second housing portion positioned on a second opposing side of the bend axis is provided. The first and second housing portions are coupled to a hinge for rotational motion about the bend axis. The hinge comprises a polymer composition that contains a polymer matrix and a plurality of reinforcing fibers distributed within the polymer matrix.

### RELATED APPLICATION

The present application is based upon and claims priority to U.S. Provisional Patent Application Ser. No. 63/499,718, having a filing date of May 3, 2023, which is incorporated herein by reference.

### BACKGROUND OF THE INVENTION

Due to the increased desire of consumers to watch movies and play high-end games on portable electronic devices (e.g., phones, tablets, etc.), there has been a demand for such devices to include large display panels for ease of viewability. Unfortunately, devices having such a large display panel cannot be readily stored. Various attempts have been made to develop electronic devices that are foldable. Such devices generally contain a display/housing structure that is coupled to a hinge so that portions of the display/housing structure can rotate about the hinge. One of the problems associated with these conventional devices, however, is that the rotational motion of the display/housing structure imparts a significant amount of stress and strain on the hinge, which can cause it to break or wear down in a short amount of time. As such, a need currently exists for a foldable electronic device having an improved hinge.

### SUMMARY OF THE INVENTION

In accordance with one embodiment of the present invention, a foldable electronic device is disclosed that comprises a housing that contains a first housing portion positioned on a first side of a bend axis and a second housing portion positioned on a second opposing side of the bend axis. The first and second housing portions are coupled to a hinge for rotational motion about the bend axis. The hinge comprises a polymer composition that contains a polymer matrix and a plurality of reinforcing fibers distributed within the polymer matrix. The polymer composition exhibits a flexural modulus of about 15,000 MPa or more as determined in accordance with ISO 178:2019 at 23° C. and a melt viscosity of about 300 Pa-s or less as determined at a shear rate of 1,000 s⁻¹ in accordance with ISO 11443:2021 at a temperature that is 15° C. higher than a melting temperature of the composition.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a perspective view of one embodiment of a foldable electronic device of the present invention;

FIG. 2 is a cross-sectional side view of one embodiment of a foldable electronic device of the present invention;

FIG. 3 is a side view of a portion of one embodiment of a foldable electronic device having a hinge with links;

FIG. 4 is a side view of a portion of one embodiment of a hinge that may be employed in a foldable electronic device;

FIG. 5 is a top view of one embodiment of a hinge that may be employed in a foldable electronic device having interleaved fingers; and

FIG. 6. is a top view of a portion of one embodiment of a foldable electronic device having structures coupled to hinge fingers.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a foldable electronic device that contains a housing having a first housing portion positioned on a first side of a bend axis and a second housing portion positioned on an opposing second side of the bend axis. The first and second housing portions are coupled by a hinge for rotational motion about the bend axis. Notably, the hinge contains a polymer composition that contains a polymer matrix and a plurality of reinforcing fibers distributed within the polymer matrix. By selectively controlling the particular nature of the polymer and reinforcing fibers, as well as their relative concentration within the composition, the present inventor has discovered that the resulting composition can achieve a unique combination of properties for use in the hinge.

The polymer composition may, for example, exhibit a flexural modulus of about 15,000 MPa or more, in some embodiments from about 19,000 MPa to about 40,000 MPa, in some embodiments from about 20,000 MPa to about 25,000 MPa, and in some embodiments, from about 28,000 MPa to about 40,000 MPa, as determined in accordance with ISO 178:2019 at 23° C. Such a high flexural modulus may, among other things, help prevent the hinge from bending to a significant degree when the housing portions are folded about the bend axis. The polymer composition may also exhibit a flexural strength of from about 100 to about 500 MPa, in some embodiments from about 150 to about 400 MPa, and in some embodiments, from about 250 to about 350 MPa, and/or a flexural break strain of about 0.3% or more, in some embodiments from about 0.8% to about 5%, and in some embodiments, from about 1.1% to about 3%, as determined in accordance with ISO 178:2019 at 23° C. The composition may also exhibit a high degree of impact strength, such as exhibited by a high Charpy notched impact strength of about 5 kJ/m² or more, in some embodiments from about 6 to about 30 kJ/m², and in some embodiments, from about 7 to about 25 kJ/m², and/or a Charpy unnotched impact strength of about 10 kJ/m² or more, in some embodiments from about 12 kJ/m² to about 50 kJ/m², in some embodiments from about 14 to about 45 kJ/m², and in some embodiments, from about 15 to about 35 kJ/m² measured at 23° C. according to ISO 179-1:2010.

Of course, in addition to exhibiting good flexural strength properties and a high impact strength, the polymer composition may also exhibit good tensile strength properties. For example, the tensile modulus of the composition may generally be about 16,000 MPa or more, in some embodiments about 20,000 MPa or more, in some embodiments from about 20,500 MPa to about 40,000 MPa, in some embodiments from about 21,000 MPa to about 36,000 MPa, in some embodiments from about 22,000 MPa to about 25,000 MPa, and in some embodiments, from about 30,000 MPa to about 36,000 MPa as determined in accordance with ISO 527:2019 at 23° C. The composition may also exhibit a tensile strength of from about 120 to about 500 MPa, in some embodiments from about 150 to about 400 MPa, and in some embodiments, from about 160 to about 350 MPa, and/or a tensile break strain of about 0.3% or more, in some embodiments from about 0.5% to about 5%, and in some embodiments, from about 0.7% to about 3%, as determined in accordance with ISO 527:2019 at 23° C.

While possessing good strength properties as noted above, the polymer composition is also highly flowable, which can facilitate the ability to use the composition in hinges having a very small thickness and/or overall size. The thickness of the hinge may, for example, be from 0.01 to about 5 millimeters, in some embodiments from about 0.05 to about 2.5 millimeters, and in some embodiments, from about 0.1 to about 1 millimeter. The polymer composition may have a melt viscosity of about 300 Pa-s or less, in some embodiments about 200 Pa-s or less, in some embodiments from about 5 to about 180 Pa-s, in some embodiments from about 10 to about 100 Pa-s, in some embodiments from about 12 to about 80 Pa-s, and in some embodiments, from about 15 to about 60 Pa-s, as determined at a shear rate of 1,000 s⁻¹ in accordance with ISO 11443:2021 at a temperature that is 15° C. higher than the melting temperature of the composition. The heat resistance of the polymer composition may also be good. For example, the melting temperature of the composition may be about 250° C. or more, in some embodiments about 280° C. or more, in some embodiments about 290° C. or more, in some embodiments about 300° C. or more, and in some embodiments, from about 310° C. to about 360° C. Further, the deflection temperature under load (DTUL) may be about 180° C. or more, in some embodiments from about 200° C. to about 350° C., in some embodiments from about 225° C. to about 325° C., and in some embodiments, from about 230° C. to about 300° C., as measured according to ASTM D648-18 (technically equivalent to ISO 75-2:2013) at a specified load of 1.8 MPa.

Various embodiments of the present invention will now be described in more detail.

### I. Polymer Composition

### A. Polymer Matrix

The polymer matrix typically contains one or more high performance polymers, generally in an amount of from about 30 wt. % to about 90 wt. %, in some embodiments from about 45 wt. % to about 75 wt. %, in some embodiments from about 50 wt. % to about 70 wt. %, and in some embodiments, from about 55 wt. % to about 65 wt. % of the entire polymer composition.

Such polymers are generally considered “high performance” polymers in that they are selected to have a relatively high glass transition temperature and/or high melting temperature such that they provide a substantial degree of heat resistance to the polymer composition. For example, the polymer may have a melting temperature of about 250° C. or more, in some embodiments about 260° C., in some embodiments about 280° C. or more, in some embodiments from about 290° C. to about 400° C., and in some embodiments, from about 310° C. to about 360° C. The polymer may also have a glass transition temperature of about 30° C. or more, in some embodiments about 40° C. or more, in some embodiments from about 50° C. to about 250° C., in some embodiments from about 60° C. to about 150° C. The glass transition and melting temperatures may be determined as is well known in the art using differential scanning calorimetry (“DSC”), such as determined by ISO 11357-2:2020 (glass transition) and 11357-3:2018 (melting).

Polyarylene sulfides, for instance, are suitable semi-crystalline aromatic polymers for use in the polymer composition. The polyarylene sulfide may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

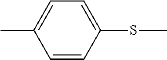

and segments having the structure of formula:

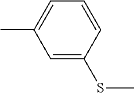

or segments having the structure of formula:

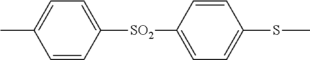

The polyarylene sulfide may be linear, semi-linear, branched or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

Another suitable high performance polymer may be a thermotropic liquid crystalline polymer. Liquid crystalline polymers are generally classified as “thermotropic” to the extent that they can possess a rod-like structure and exhibit a crystalline behavior in their molten state (e.g., thermotropic nematic state). Such polymers may be formed from one or more types of repeating units as is known in the art. A liquid crystalline polymer may, for example, contain one or more aromatic ester repeating units generally represented by the following Formula (I):

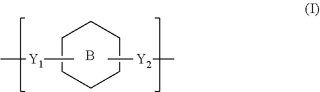

wherein,
ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and
Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic hydroxycarboxylic repeating units, for instance, may be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute about 30 mol. % or more, in some embodiments from about 40 mol. % to about 80 mol. %, and in some embodiments, from about 50 mol. % to 70 mol. % of the polymer.

Aromatic dicarboxylic repeating units may also be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl) ether, bis(4-carboxyphenyl) butane, bis(4-carboxyphenyl) ethane, bis(3-carboxyphenyl) ether, bis(3-carboxyphenyl) ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) each typically constitute from about 1 mol. % to about 50 mol. %, in some embodiments from about 2 mol. % to about 40 mol. %, and in some embodiments, from about 5 mol. % to about 30 mol. % of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl) ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) each typically constitute from about 1 mol. % to about 30 mol. %, in some embodiments from about 2 mol. % to about 25 mol. %, and in some embodiments, from about 5 mol. % to about 20 mol. % of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10 mol. % of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

In some embodiments, the composition contains a “low naphthenic” liquid crystalline polymer containing a low content of repeating units derived from naphthenic hydroxycarboxylic acids and naphthenic dicarboxylic acids, such as naphthalene-2,6-dicarboxylic acid (“NDA”), 6-hydroxy-2-naphthoic acid (“HNA”), or combinations thereof. That is, the total amount of repeating units derived from naphthenic hydroxycarboxylic and/or dicarboxylic acids (e.g., NDA, HNA, or a combination of HNA and NDA) can be about 15 mol. % or less, in some embodiments about 10 mol. % or less, in some embodiments about 6 mol. % or less, and in some embodiments, from 0 mol. % to about 5 mol. % of the polymer. In one embodiment, for instance, the repeating units derived from HNA and/or NDA may be 0 mol. % of the polymer. In such embodiments, the polymer may contain repeating units derived from HBA in an amount of from about 40 mol. % to about 80 mol. %, and in some embodiments from about 45 mol. % to about 75 mol. %, and in some embodiments, from about 50 mol. % to about 70 mol. %. The polymer may also contain aromatic dicarboxylic acid(s) (e.g., IA and/or TA) in an amount of from about 1 mol. % to about 20 mol. %, and in some embodiments, from about 4 mol. % to about 15 mol. %, and/or aromatic diol(s) (e.g., BP and/or HQ) in an amount of from about 1 mol. % to about 20 mol. %, and in some embodiments, from about 4 mol. % to about 15 mol. %. In certain instances, the molar ratio of BP to HQ may be selectively controlled so that it is from about 0.8 to about 2.5, in some embodiments from about 1 to about 2.2, and in some embodiments, from about 1.1 to about 2 and/or the molar ratio of TA to IA may be selectively controlled so that it is from about 0.8 to about 2.5, in some embodiments from about 1 to about 2.2, and in some embodiments, from about 1.1 to about 2. For example, BP may be used in a molar amount greater than HQ such that the molar ratio is greater than 1 and/or TA may be used in a molar amount greater than IA such that the molar ratio is greater than 1.

In some embodiments, the polymer composition contains a “high naphthenic” liquid crystalline polymer containing a relatively high content of repeating units derived from naphthenic hydroxycarboxylic acids and naphthenic dicarboxylic acids, such as naphthalene-2,6-dicarboxylic acid (“NDA”), 6-hydroxy-2-naphthoic acid (“HNA”), or combinations thereof. That is, the total amount of repeating units derived from naphthenic hydroxycarboxylic and/or dicarboxylic acids (e.g., NDA, HNA, or a combination of HNA and NDA) can be greater than about 15 mol. %, in some embodiments about 18 mol. % or more, and in some embodiments, from about 20 mol. % to about 60 mol. % of the polymer. In one particular embodiment, for instance, the repeating units derived from 6-hydroxy-2-naphthoic acid (“HNA”) may constitute from about 10 mol. % to about 40 mol. %, in some embodiments from about 15 mol. % to about 35 mol. %, and in some embodiments, from about 20 mol. % to about 30 mol. % of the polymer. In such embodiments, the liquid crystalline polymer may also contain various other monomers, such as aromatic hydroxycarboxylic acid(s) (e.g., HBA) in an amount of from about 10 mol. % to about 85 mol. %, in some embodiments from about 40 mol % to about 82 mol % and in some embodiments, from about 70 mol. % to about 80 mol. %; aromatic dicarboxylic acid(s) (e.g., IA and/or TA) in an amount of from about 0 mol. % to about 30 mol. %, and in some embodiments, from about 2 mol. % to about 25 mol. %; and/or aromatic diol(s) (e.g., BP and/or HQ) in an amount of from about 0 mol. % to about 40 mol. %, and in some embodiments, from about 2 mol. % to about 35 mol. %. In some embodiments, the high naphthenic liquid crystalline polymer contains a small amount of aromatic dicarboxylic acid in addition to a naphthenic hydroxycarboxylic acid and HBA. For instance, the liquid crystalline polymer can contain TA and/or IA in an amount from about 0.1 mol. % to about 5 mol. %, in some embodiments from about 0.2 mol. % to about 2 mol. %, and in some embodiments, from about 0.5 mol. % to about 1 mol. %.

In certain embodiments, all of the liquid crystalline polymers are “low naphthenic” polymers such as described above. In other embodiments, all of the liquid crystalline polymers are “high naphthenic” polymers such as described above. In some cases, blends of such polymers may also be used. For example, low naphthenic liquid crystalline polymers may constitute from about 50 wt. % to about 95 wt. %, in some embodiments from about 60 wt. % to about 90 wt. %, and in some embodiments, from about 75 wt. % to about 85 wt. % of the total amount of liquid crystalline polymers in the composition, and high naphthenic liquid crystalline polymers may constitute from about 5 wt. % to about 50 wt. %, in some embodiments from about 10 wt. % to about 40 wt. %, and in some embodiments, from about 15 wt. % to about 25 wt. % of the total amount of liquid crystalline polymers in the composition. In other embodiments, high naphthenic liquid crystalline polymers may constitute from about 50 wt. % to about 99 wt. %, in some embodiments from about 80 wt. % to about 97 wt. %, and in some embodiments, from about 90 wt. % to about 95 wt. % of the total amount of liquid crystalline polymers in the composition, and low naphthenic liquid crystalline polymers may constitute from about 1 wt. % to about 50 wt. %, in some embodiments from about 3 wt. % to about 20 wt. %, and in some embodiments, from about 5 wt. % to about 10 wt. % of the total amount of liquid crystalline polymers in the composition.

### B. Reinforcing Fibers

Reinforcing are also dispersed within the polymer matrix. Any of a variety of different types of reinforcing fibers may generally be employed in the polymer composition of the present invention, such as polymer fibers, metal fibers, carbonaceous fibers (e.g., graphite, carbide, etc.), inorganic fibers, etc., as well as combinations thereof. In some embodiments, the composition contains inorganic fibers, such as those that are derived from glass; titanates (e.g., potassium titanate); silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Glass fibers may be particularly suitable for use in the present invention, such as those formed from E-glass, A-glass, C-glass, D-glass, AR-glass, R-glass, S1-glass, S2-glass, etc., as well as mixtures thereof. Carbon fibers are also particularly suitable for use in the polymer composition, as they generally have high stiffness. If desired, the reinforcing fibers may be provided with a sizing agent or other coating as is known in the art.

When employed, the carbon fibers may exhibit a high intrinsic thermal conductivity, such as about 200 W/m-k or more, in some embodiments about 500 W/m-K or more, in some embodiments from about 600 W/m-K to about 3,000 W/m-K, and in some embodiments, from about 800 W/m-K to about 1,500 W/m-K, as well as a low intrinsic electrical resistivity (single filament) of less than about 20 μohm-m, in some embodiments less than about 10 μohm-m, in some embodiments from about 0.05 to about 5 μohm-m, and in some embodiments, from about 0.1 to about 2 μohm-m. In addition to exhibiting a high degree of intrinsic thermal conductivity and low volume resistivity, such fibers also generally have a high degree of tensile strength relative to their mass. For example, the tensile strength of the fibers is typically from about 500 to about 10,000 MPa, in some embodiments from about 600 MPa to about 4,000 MPa, and in some embodiments, from about 800 MPa to about 2,000 MPa, such as determined in accordance with ASTM D4018-17. The fibers may have an average diameter of from about 1 to about 200 micrometers, in some embodiments from about 1 to about 150 micrometers, in some embodiments from about 3 to about 100 micrometers, and in some embodiments, from about 5 to about 50 micrometers. The fibers may be continuous filaments, chopped, or milled. In certain embodiments, for instance, the fibers may be chopped fibers having a volume average length of the fibers may likewise range from about 0.1 to about 15 millimeters, in some embodiments from about 0.5 to about 12 millimeters, and in some embodiments, from about 1 to about 10 millimeters.

The nature of the carbon fibers may vary, such as carbon fibers obtained from cellulose, lignin, polyacrylonitrile (PAN) and pitch. Pitch-based and PAN-based carbon fibers are particularly suitable for use in the polymer composition. In some embodiments, the carbon fibers are not coated by a metal. Further, in some embodiments, the carbon fibers do not contain carbon nanotubes.

In some embodiments, the carbon fibers include recycled carbon fibers. The recycled carbon fibers may be obtained through various methods known in the art. For example, in some embodiments, carbon fibers which have been formed into a carbon fiber fabric, but which have not been impregnated by a polymer, may be broken down into individual carbon fibers, especially short carbon fibers. An example of a process for recycling carbon fibers into short carbon fiber lengths is disclosed by German Patent Application DE 102009023529, which is incorporated herein by reference.

In other embodiments, the recycled carbon fibers are obtained from carbon fiber-reinforced polymers (CFRPs). One CFRP recycling technique involves subjecting waste CFRP to pyrolysis. This technique utilizes high temperatures to decompose polymeric matrix while attempting to leave the reinforcing fibers intact. Another type of CFRP recycling technique uses chemical agents to chemically react with, degrade, and break down the polymeric matrix (sometimes referred to as depolymerization) to degradation products that may be separated from the carbon fibers, such as by dissolution of the degradation products into a solvent.

A particularly suitable process includes first treating a fiber-reinforced composite with a normally-liquid solvent (e.g., methylene chloride) to prepare a first treated solid residue comprising the reinforcing fibers. The first treatment includes contacting the fiber-reinforced composite with the solvent and dissolving a majority of the matrix into the solvent. After the first treatment, a second treatment of at least a portion of the first treated solid residue comprising the reinforcing fibers with a normally-gaseous material (e.g., carbon dioxide) is preformed to prepare a second treated solid residue. The second treatment includes contacting at least a portion of the first treated solid residue with the normally-gaseous material under conditions of temperature and pressure at which the normally-gaseous material is in a form of a liquid or supercritical fluid. The second treatment may be particularly beneficial for removing residual solvent from the first treated solid residue and may also beneficially remove some additional residual matrix material.

The first treatment may be conducted at any convenient temperature (e.g., temperature of the solvent), but is typically conducted at a temperature that is lower than a normal boiling point of the solvent and is conveniently conducted at ambient temperature. The dissolving may be conducted under an elevated pressure but is often conducted at ambient pressure (approximately one bar). The solvent may include any one or any combination of two or more of the following, with or without other additional components: methylene chloride, methoxy-nonafluorobutane, 2-methyltetrahydrofuran, tetrahydrofuran, tetrachloroethylene, n-propyl bromide, dimethyl sulfoxide, polyolester oil, esters, ethers, acetates, acids, alkalis, amines, ketones, glycol ethers, glycol ether esters, ether esters, ester-alcohols, alcohols, halogenated hydrocarbons, paraffinic hydrocarbons, aliphatic hydrocarbons, aromatic hydrocarbons, and combinations thereof. Methylene chloride is preferred. The normally-gaseous material may include any one or any combination of two or more of the following, with or without the presence of any other component or components: carbon dioxide, 1,1,1,2-tetrafluoroethane, difluoromethane, pentafluoroethane, and combinations thereof. In preferred implementations, the normally-gaseous material is chemically nonreactive, and even more preferably is chemically inert, with respect to the reinforcing fibers. Carbon dioxide is preferred.

The pressure during the second treatment may be within a range of 3 MPa to 69 MPa, such as from about 7 MPa to about 10 MPa. The temperature during second treatment may be within a range from about 0° C. to about 175° C., such as from about 20° C. to about 40° C. A supercritical fluid refers to a fluid at a temperature and pressure above the critical temperature and critical pressure for the material, for example at a temperature above 31.1° C. and a pressure above 72.9 atmospheres (7.39 MPa) in the case of carbon dioxide as the normally-gaseous material. After the second treatment, the vessel can be rapidly depressurized to ambient pressure, which can cause the normally-gaseous material to solidify due to gas expansion cooling. The solidified material can then be sublimated by rinsing with hot water.

The above process is capable of producing recycled carbon fibers which have mechanical properties similar to virgin carbon fibers. U.S. Pat. Nos. 10,487,191; 10,610,911; and 10,829,611, which are incorporated herein by reference, describe carbon fiber recycling processes which are suitable for producing recycled carbon fiber which may be used in the present composition.

The amount of reinforcing fibers may be selectively controlled to achieve the desired combination of stiffness and heat resistance. The reinforcing fibers may, for example, be employed in an amount of from about 10% to about 70%, in some embodiments from about 20% to about 60%, in some embodiments from about 30% to about 55%, in some embodiments from about 35 wt. % to about 50 wt. %, and in some embodiments, from about 35% to about 45%, by weight of the polymer composition. In some embodiments, the reinforcing fibers comprise only glass fibers. In other embodiments, the composition contains both glass fibers and carbon fibers. In such embodiments, the ratio of glass fibers to carbon fibers can be from about 1:10 to about 25:1, in some embodiments from about 1:1 to about 20:1, in some embodiments from in some embodiments from about 2:1 to about 15:1, in some embodiments from about 5:1 to about 15:1, and in some embodiments, from about 6:1 to about 13:1. For instance, in one embodiment, glass fibers may comprise from about 10 wt. % to about 50 wt. %, in some embodiments from about 15 wt. % to about 45 wt. %, and in some embodiments, from about 25 wt. % to about 40 wt. % of the composition, while carbon fibers may comprise from about 0.5 wt. % to about 10 wt. %, in some embodiments from about 1 wt. % to about 8 wt. %, and in some embodiments, from about 1.5 wt. % to about 7 wt. % of the composition.

In some embodiments, the reinforcing fibers may contain only carbon fibers. In such embodiments, the carbon fibers may constitute from about 10 wt. % to about 50 wt. %, such as from about 25 wt. % to about 40 wt. % of the composition.

### C. Optional Components

A wide variety of additional additives can also be included in the polymer composition, such as particulate fillers (e.g., talc, mica, etc.), antimicrobials, pigments (e.g., carbon black), antioxidants, stabilizers, surfactants, waxes, solid solvents, flame retardants, anti-drip additives, and other materials added to enhance properties and processability. Lubricants may also be employed in the polymer composition that are capable of withstanding the processing conditions of the high performance polymer without substantial decomposition. Examples of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide. When employed, the lubricant(s) typically constitute from about 0.05 wt. % to about 1.5 wt. %, and in some embodiments, from about 0.1 wt. % to about 0.5 wt. % (by weight) of the polymer composition.

The components used to form the polymer composition may be combined together using any of a variety of different techniques as is known in the art. In one particular embodiment, for example, the high performance polymer, reinforcing fibers, and other optional additives are melt processed as a mixture within an extruder to form the polymer composition. The mixture may be melt-kneaded in a single-screw or multi-screw extruder, such as at a temperature of from about 250° C. to about 450° C. In one embodiment, the mixture may be melt processed in an extruder that includes multiple temperature zones. The temperature of individual zones is typically set within about −60° C. to about 25° C. relative to the melting temperature of the polymer. By way of example, the mixture may be melt processed using a twin screw extruder such as a Leistritz 18-mm co-rotating fully intermeshing twin screw extruder. A general purpose screw design can be used to melt process the mixture. In one embodiment, the mixture including all of the components may be fed to the feed throat in the first barrel by means of a volumetric feeder. In another embodiment, different components may be added at different addition points in the extruder, as is known. For example, the polymer may be applied at the feed throat, and certain additives (e.g., reinforcing fibers) may be supplied at the same or different temperature zone located downstream therefrom. Regardless, the resulting mixture can be melted and mixed then extruded through a die. The extruded polymer composition can then be quenched in a water bath to solidify and granulated in a pelletizer followed by drying.

### II. Foldable Electronic Device

As indicated above, the polymer composition of the present invention is particularly well suited for use in a foldable electronic device. More particularly, the electronic device generally contains a housing having a first portion positioned on one side of a bend axis and a second portion positioned on an opposing side of the bend axis. The first and second housing portions are coupled by a hinge for rotational motion about the bend axis. The electronic device may be a cellular telephone, tablet computer, laptop computer, wristwatch device or other wearable device, a television, a stand-alone computer display or other monitor, a computer display with an embedded computer (e.g., a desktop computer), a system embedded in a vehicle, kiosk, or other embedded electronic device, a media player, or other electronic equipment.

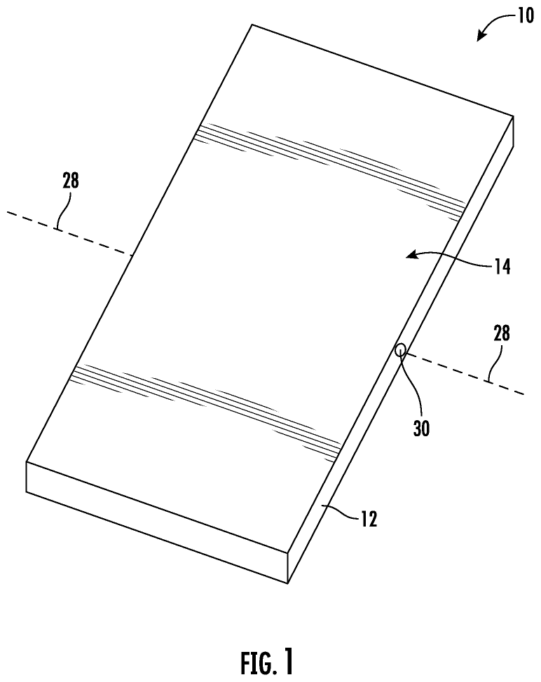

Referring to FIG. 1, for example, one embodiment of an electronic device 10 is shown that is in the form of a portable electronic device, such as a cellular telephone or tablet computer. As shown, the device 10 may have a display 14. The display 14 may cover some or all of the front face of device 10. Touch sensor circuitry, such as two-dimensional capacitive touch sensor circuitry, may be incorporated into display 14. The display 14 may be mounted in a housing 12. The housing 12 may form front and rear housing walls, sidewall structures, and/or internal supporting structures (e.g., a frame, an optional midplate member, etc.) for the device 10. Glass structures, transparent polymer structures, and/or other transparent structures that cover the display 14 and other portions of device 10 may provide structural support for the device 10 and may sometimes be referred to as housing structures. For example, a transparent housing portion, such as a glass or polymer housing structure that covers and protects a pixel array in display 14, may serve as a display cover layer for the pixel array while also serving as a housing wall on the front face of device 10. In configurations in which a display cover layer is formed from glass, the display cover layer may sometime be referred to as a display cover glass or display cover glass layer. The portions of the housing 12 on the sidewalls and rear wall of device 10 may be formed from glass or other transparent structures and/or opaque structures. Sidewalls and rear wall structures may be formed as extensions to the front portion of housing 12 (e.g., as integral portions of the display cover layer) and/or may include separate housing wall structures.

The housing 12 generally has a first portion on one side of a bend axis 28 and a second portion on an opposing side of the bend axis 28. The housing portions may be coupled by a hinge 30 for rotational motion about the bend axis 28. As the housing 12 is bent about the bend axis 28, the flexibility of the display 14 allows it to bend about the axis 28. In an illustrative configuration, for example, the housing 12 and display 14 may bend by about 180°. This allows the display 14 to be folded back on itself (with first and second outwardly-facing portions of display 14 facing each other). The ability to place the device 10 in a folded configuration may help make the device 10 compact so that it can be stored efficiently. When it is desired to view images on display 14, the device 10 may be unfolded about the bend axis 28 to place it in the unfolded configuration of FIG. 1. This allows the display 14 to lie flat and allows a user to view flat images on display 14. The ability to fold the display 14 onto itself allows the device 10 to exhibit an inwardly folding behavior. The display 14 may be sufficiently flexible to allow device 10 to be folded outwardly and/or inwardly.

The device 10 of FIG. 1 has a rectangular outline (rectangular periphery) with four corners. As shown, a first pair of parallel edges (e.g., the left and right edges) may be longer than a second pair of parallel edges (e.g., the upper and lower edges) that are oriented at right angles to the first pair of parallel edges. In this type of configuration, the housing 12 is elongated along a longitudinal axis that is perpendicular to the bend axis 28. The housing 12 may have other shapes, if desired (e.g., shapes in which housing 12 has a longitudinal axis that extends parallel to the bend axis 28). With an arrangement of the type shown in FIG. 1, the length of the device 10 along its longitudinal axis may be reduced by folding device 10 about the bend axis 28.

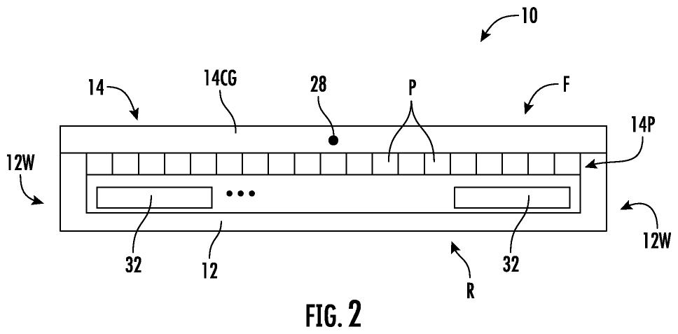

FIG. 2 is a cross-sectional side view of an illustrative foldable electronic device. As shown, the device may be bent about the bend axis 28, which may be aligned with a display cover layer 14CG or other structures in the device 10. For example, the bend axis 28 may pass through a portion of the display cover layer 14CG or may be located above or below the layer 14CG. The display 14 includes an array of pixels P forming a display panel 14P under an inwardly facing surface of the display cover layer 14CG. The display panel 14P may be, for example, a flexible organic light-emitting diode display or a microLED display in which light-emitting pixels are formed on a flexible substrate layer (e.g., a flexible layer of polyimide or a sheet of other flexible polymer). Flexible support layer(s) for the display 14 may also be formed from flexible glass, flexible metal, and/or other flexible structures. The display cover layer 14CG may be formed from polymer, glass, crystalline materials such as sapphire, other materials, and/or combinations of these materials. To locally increase flexibility, a portion of the layer 14CG that overlaps and extends along the bend axis 28 (e.g., a strip-shaped region running along the bend axis 28 and the hinge 30) may be locally thinned (e.g., this portion may be thinned relative to portions of layer 14CG that do not overlap bend axis 28).

In the embodiment of FIG. 2, the housing 12 has a portion on a rear face R that forms a rear housing wall and has side portions forming sidewalls 12W. The rear housing wall may form a support layer for components in the device 10. The housing 12 may also have one or more interior supporting layers (e.g., frame structures such as an optional midplate, etc.). These interior supporting layers and the rear housing wall may have first and second portions that are coupled to opposing sides of a hinge that is aligned with the bend axis 28 (see, e.g., hinge 30 of FIG. 1) or may be sufficiently flexible to bend around the bend axis 28. Electrical components 32 may be mounted in the interior of device 10 (e.g., between display 14 and the rear of housing 1, such as control circuitry, communications circuitry, input-output devices, batteries, etc. The display 14 may be mounted on a front face F of the device 10. When the device 10 is folded about the bend axis 28, the display cover layer 14CG, display panel 14P, and other structures of the device 10 that overlap the bend axis 28 may flex and bend to accommodate folding.

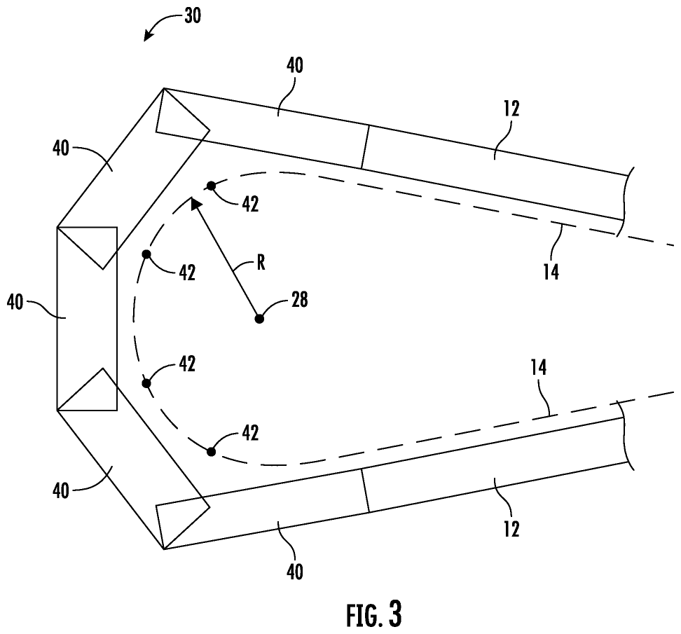

The hinge 30 may have a variety of different configurations as are known in the art. In one embodiment, for example, the hinge may have a multilink configuration. Referring to FIG. 3, for example, one embodiment of the hinge 30 is shown that include multiple interconnected portions (or links) 40. The links 40 may be coupled to each other for rotational motion and may extend in a linked series between the first and second portions of the housing 12 that rotate with respect to each other. Each pair of adjacent hinge links may be restricted in its amount of overall rotation. For example, the links 40 may be configured so that no two adjacent links 40 are allowed to rotate more than a maximum rotation angle RA with respect to each other where RA has a value of less than 180°, less than 90°, less than 45°, less than 25°, 5-50°, or other suitable amount. With this arrangement, the links 40 may collectively allow the hinge 30 to rotate by a desired amount (e.g., 180°) without creating an excessively small bend radius for the display 14 about the bend axis 28. The value of RA may be the same for all pairs of adjacent links 40 or different pairs of adjacent links may have different values of RA. As an example, the angle RA may be 30° for the link pairs that are adjacent to housing 12, whereas the angle RA may be 60° for the link pairs in the middle of hinge 30. Arrangements where each link rotates by the same maximum angle RA with respect to its neighboring links and/or in which the middle links 40 in hinge 30 have higher RA values than the links immediately adjacent to housing 12 may also be used, if desired.

With an illustrative arrangement, the links 40 may have crescent shaped slots with mating pins and/or other structures (e.g., links with mating crescent-shaped bearing surfaces) that place the axes of rotations of the links outside of the layer of links themselves. As shown in FIG. 3, for example, each link in a pair of adjacent links may rotate with respect to the other about a rotational axis 42 that is located outside of the links towards the bend axis 28. Although each adjacent set of links can only rotate by a limited amount in this type of arrangement, the overall amount of bending of display 14 may be 180° or more by using multiple links 40 in the hinge 30, thereby allowing the display 14 to fold back on itself. To help minimize bending stress, the display 14 may be placed in alignment with axes 42. The bend radius R of the display 14 when the device 10 is folded shut may be sufficient to prevent excess stress to display 14. For example, R may have a value of 5 mm, at least 1 mm, at least 3 mm, less than 10 mm, less than 6 mm, 2-7 mm, or other suitable value).

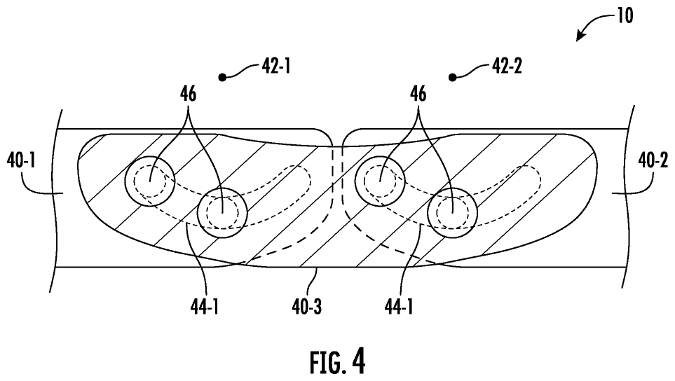

FIG. 4 is a side view of a set of multiple hinge links 40 in a portion of the hinge 30. There may be any suitable number of links 40 in the hinge 30. For example, the hinge 30 may contain at least 2 links, in some embodiments at least 3 links, in some embodiments from 3 to 15 links, and in some embodiments, from 4 to 12 links. In the illustrated embodiment, a first link 40-1 has a crescent-shaped slot 44-1 and a second link 40-2 has crescent-shaped slot 44-2. Pins 46 and a third link 40-3 may be used to couple the links 40-1 and 40-2. During operation, pins 46 and the slots of the hinge 30 allow adjacent links 40-1 and 40-3 to rotate with respect to each other about rotational axis 42-1 and allow adjacent links 40-3 and 40-2 to rotate with respect to each other about rotational axis 42-2. As shown, rotational axes 42-1 and 42-2 are located out of the plane of the links 40 (e.g., above links 40), which allows the display 14 (e.g., a flexible thin-film display such as a flexible thin-film organic light-emitting diode display, a microLED display, or other flexible display) to be mounted so that potentially sensitive thin-film layers of the display, a display cover layer in the display, and/or other sensitive portions of the display are aligned with axes 42-1 and 42-2. In this way, the locations of axes 42-1 and 42-2 may establish a neutral stress plane for display 14 that coincides with the thin-film layers, display cover layer, and/or other sensitive portions of display 14. The lengths of the crescent-shaped slots and the amount of curvature of each slot may be selected to adjust the locations of axes 42-1 and 42-2 (e.g., the distance of these axes above links 40) and to adjust the amount of permitted rotation of each link with respect to the next. If, as an example, slots 44-1 and 44-2 are nearly straight, axes 42-1 and 42-2 will be relatively far from links 44, whereas if slots 44-1 and 44-2 exhibit strong curvature, then axes 42-1 and 42-2 will be close to links 44. For a given curvature, slot length affects the amount of permitted motion. If the slots are long, more rotational motion of the links will be permitted (because pins 46 will have farther to slide along the length of the slots), whereas if the slots are short, less rotational motion of the links will be permitted before the pins reach the ends of the slots and are prevented from sliding further.

To maintain satisfactory friction between rotating parts of device 10, the hinge 30 may optionally be provided with friction clutch structures. As an example, adjacent links 40 and/or other portions of the hinge 30 may be provided with interdigitated sets of fingers that are pressed together to create rotational friction when rotating with respect to each other. These friction-producing structures, which may sometimes be referred to as friction clutch structures, a friction clutch, a hinge friction structure, rotational friction structures, etc., may be integrated into links 40 or attached to links 40 so that the friction-producing structures produce rotational friction for the attached links 40, and/or may otherwise be coupled between portions of housing 12 that rotate with respect to each other. The friction produced by the friction clutch structures allows a first portion of housing 12 to be maintained in a desired rotational orientation with respect to a second portion of housing 12 (e.g., housing halves may be placed perpendicular or nearly perpendicular to each other, may be closed onto each other, may be placed in an open planar configuration, and/or may otherwise be positioned as desired by rotating these portions with respect to each other about the bend axis 28 of hinge 30).

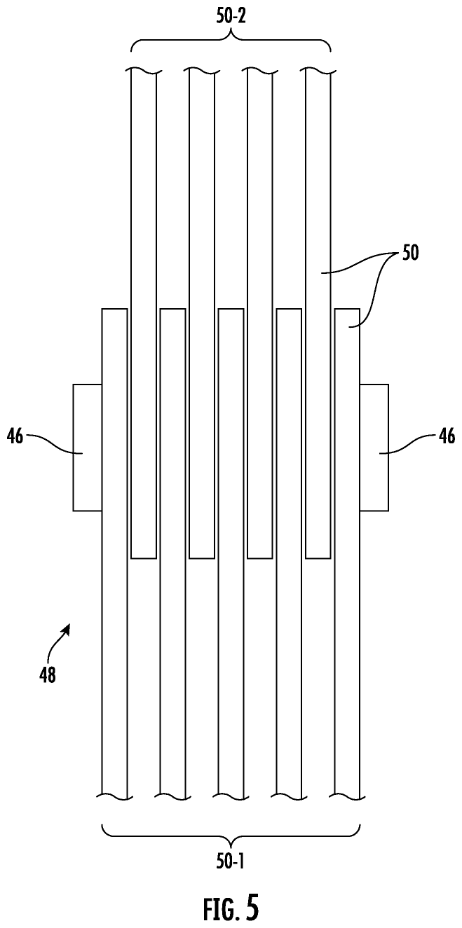

FIG. 5 is a top view of a friction clutch formed from interdigitated friction clutch members. In the illustrated embodiment, a clutch 48 has a first set of fingers 50 (e.g., first fingers 50-1) and a second set of fingers 50 (e.g., second fingers 50-2). The fingers 50 in the first and second sets are interdigitated. Pins 46 may be configured to press fingers 50 towards each other along the axis passing through pin 46. The fingers 50 may be relatively thin (e.g., fingers 50 may have a relatively small dimension along the axis of pin 46) and may have relatively larger surface areas where fingers 50 contact each other (e.g., fingers 50 may form blade-shaped members). This allows friction to be created without requiring an overly bulky clutch. The pins 46 may be configured to squeeze fingers 50-1 and 50-2 together to impart a desired amount of friction (e.g., sufficient friction to hold first and second portions of housing 12 at a desired angle relative to each to each other when the first portion is resting on a surface). In an illustrative configuration, two pins 46 are used to couple each adjacent set of fingers 50 and each adjacent set of fingers 50 forms a corresponding link 40. The pair of pins 46 may travel within a crescent shaped slot in the set of fingers 50 that form the link, as described in connection with slots 44-1 an 44-2 of FIG. 4.

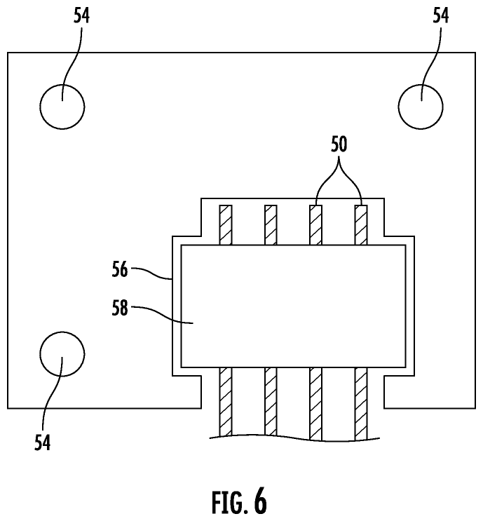

The fingers 50 may be coupled to the housing 12 using any suitable arrangement (e.g., using welds, adhesive, fasteners, press-fit connections, interlocking engagement structures such as interlocking clips, and/or other mounting structures). Referring to FIG. 6, for instance, the fingers 50 (e.g., fingers 50 in one of hinge links 40) may be attached to a hinge mounting member 52. The hinge mounting member 52, which may sometimes be referred to as a housing structure or housing portion, may be formed as an integral portion of a housing wall or other structure(s) of the housing 12 (e.g., member 52 may form part of one of the halves of housing 12 that rotate relative to each other) or may be formed from a separate structure that is attached to a portion of housing 12. There may be, as an example, a pair of members 52 attached to one half of housing 12 (e.g., at opposing ends of axis 28) and another pair of members 52 attached to corresponding portion of another half of housing 12 (and optionally additional pairs of members 52 at one or more additional locations along the length of axis 28). The hinge 30 may have a first set of links that form a first hinge portion spanning between two of the members 52 (e.g., at one end of axis 28) and may have a second set of links that form a second hinge portion spanning between two more of the members 52 (e.g., at an opposing end of axis 28). Arrangements with a different number of hinge structures coupled to members 52 and/or different numbers of members 52 may also be used. As shown, each member 52 may have openings such as through-hole openings 54 that allow screws or other fasteners to be used to attach the member 52 to the housing 12. If desired, the fingers 50 may be received within one or more recesses in the member 52, such as recess 56. The fingers 50 may be mounted in the recess 56 under a mounting plate, such as plate 58, that helps hold fingers 50 within the recess 56. The plate 58 may be attached to the member 52 using welds, adhesive, fasteners, press-fit connections, interlocking engagement structures, and/or other mounting structures.

To help ensure that the links rotate evenly throughout the hinge, the device may also contain intermeshed gears (not shown) that extend between rotating portions of the housing (e.g., in parallel with the hinge). The gears and/or other rotation synchronization structures may help ensure that movement of a first portion of the housing can produce equal and opposite movement of the second portion of the housing. In one embodiment, for instance, a first set of gears is located in a first plane and a second set of gears is located in a parallel second plane that is offset from the first plane. During bending, the first and second sets of gears work together to synchronize motion of the first and second portions of the housing. Various embodiments in which such intermeshing gears are employed in a foldable electronic device are described in more detail, for instance, in U.S. Patent Publication No. 2023/0049811, which is incorporated herein by reference.

The polymer composition of the present invention may be employed in any of a variety of components of the hinge of a foldable electronic device, such as described above. Referring again to FIGS. 1-6, for instance, the polymer composition may be used to form all or a portion of the hinge 30, including interconnected portions or links 40, fingers 50, pins 46, hinge mounting members 52, mounting plate 58, intermeshed gears (not shown), etc. Of course, the polymer composition may also be employed in other portions of the device, such as in all or a portion of the housing 12 (e.g., first and/or second portions that fold about the bend axis 28, sidewalls 12W, etc.), display 14 (e.g., display cover layer 14CG and/or display panel P), and so forth. Regardless, the desired part(s) may be formed using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity.

The present invention may be better understood with reference to the following examples.

### Test Methods

Melt Viscosity. The melt viscosity (Pa-s) may be determined in accordance with ISO Test No. 11443:2021 at a shear rate of 1,000 s⁻¹ or 400 s⁻¹ and temperature 15° C. above the melting temperature using a Dynisco LCR7001 capillary rheometer. The rheometer orifice (die) had a diameter of 1 mm, length of 20 mm, L/D ratio of 20.1, and an entrance angle of 180°. The diameter of the barrel was 9.55 mm+0.005 mm and the length of the rod was 233.4 mm.

Melting Temperature: The melting temperature (“Tm”) may be determined by differential scanning calorimetry (“DSC”) as is known in the art. The melting temperature is the differential scanning calorimetry (DSC) peak melt temperature as determined by ISO Test No. 11357-2:2020. Under the DSC procedure, samples were heated and cooled at 20° C. per minute as stated in ISO Standard 10350 using DSC measurements conducted on a TA Q2000 Instrument.

Deflection Temperature Under Load (“DTUL”): The deflection under load temperature may be determined in accordance with ISO Test No. 75-2:2013 (technically equivalent to ASTM D648-18). More particularly, a test strip sample having a length of 80 mm, thickness of 10 mm, and width of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Tensile Modulus, Tensile Stress, and Tensile Elongation: Tensile properties may be tested according to ISO Test No. 527:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus, Flexural Stress, and Flexural Elongation: Flexural properties may be tested according to ISO Test No. 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO Test No. ISO 179-1:2010) (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C.

### Examples 1-5

Samples 1-5 are formed from various percentages of LCP 1, LCP 2, LCP 3, LCP 4, glass fiber, carbon fiber, carbon black, and a lubricant, as shown in Table 1. LCP 1 is formed from about 60 mol. % HBA, 13 mol. % TA, 12 mol. % BP, 8 mol. % HQ, and 7 mol. % IA. LCP 2 is formed from about 62.5 mol. % HBA, 5 mol. % HNA, 16.4 mol. % TA, 11.2 mol. % BP, and 5 mol. % APAP. LCP 3 is formed from 73 mol. % HBA and 27 mol. % HNA. LCP 4 is formed from 79.3 mol. % HBA, 20 mol. % HNA, and 0.7 mol. % TA. Values are provided in percent by weight of the total composition.

TABLE 1

| Sample | 1 | 2 | 3 | 4 | 5 |
|---|---|---|---|---|---|
| LCP 1 | 53.7 | 51.7 | 49.7 | 39.7 | 0 |
| LCP 2 | 4 | 4 | 4 | 4 | 4 |
| LCP 3 | 4.2 | 5.6 | 7 | 14 | 20 |
| LCP 4 | 0 | 0 | 0 | 0 | 39.7 |
| Glass Fiber | 35 | 35 | 35 | 35 | 35 |
| Carbon Fiber | 1.8 | 2.4 | 3 | 6 | 0 |
| Carbon Black | 1 | 1 | 1 | 1 | 1 |
| Lubricant | 0.3 | 0.3 | 0.3 | 0.3 | 0.3 |

Parts are injection molded from the samples of Examples 1-5 into plaques and tested for mechanical properties. The results are set forth below in Table 2.

TABLE 2

| Sample | 1 | 2 | 3 | 4 | 5 |
|---|---|---|---|---|---|
| Melt Viscosity (Pa-s) at 400 s⁻¹) | 59 | 50 | 54 | 72 | 72 |
| Melt Viscosity (Pa-s) at 1000 s⁻¹) | 40 | 35 | 36 | 45 | 45 |
| DTUL at 1.8 MPa (° C.) | 250 | 247 | 246 | 236 | 236 |
| Charpy Unnotched (kJ/m²) | 26 | 28 | 27 | 23 | 23 |
| Charpy Notched (kJ/m²) | 17 | 18 | 17 | 16 | 16 |
| Tensile Strength (MPa) | 143 | 152 | 148 | 148 | 148 |
| Tensile Modulus (MPa) | 20,740 | 21,953 | 22,735 | 24,442 | 24,442 |
| Tensile Elongation (%) | 0.98 | 0.98 | 0.9 | 0.9 | 0.89 |
| Flexural Strength (MPa) | 216 | 220 | 220 | 228 | 228 |
| Flexural Modulus (MPa) | 19,994 | 20,692 | 21,555 | 22,712 | 22,712 |
| Flexural Elongation (%) | 1.56 | 1.53 | 1.43 | 1.34 | 1.34 |

### Examples 6-11

Samples 6-11 are formed from various percentages of LCP 1, LCP 2, LCP 3, LCP 4, carbon fibers, carbon black, and a lubricant, as shown in Table 3.

TABLE 3

| Sample | 6 | 7 | 8 | 9 | 10 | 11 |
|---|---|---|---|---|---|---|
| LCP 1 | — | — | — | — | — | 64.7 |
| LCP 2 | — | — | — | — | — | 4 |
| LCP 3 | 60 | 0 | 0 | 0 | 0 | — |
| LCP 4 | 0 | 59.7 | 69.7 | 69.7 | 74.7 | — |
| Carbon Fiber | 40 | 40 | 30 | 30 | 25 | 30 |
| Carbon Black | — | — | — | — | — | 1 |
| Lubricant | 0 | 0.3 | 0.3 | 0.3 | 0.3 | 0.3 |

Parts are injection molded from the samples of Examples 6-11 into plaques and tested for mechanical properties. The results are set forth below in Table 4.

TABLE 4

| Sample | 6 | 7 | 8 | 9 | 10 | 11 |
|---|---|---|---|---|---|---|
| Melt Viscosity (Pa-s) at 400 s⁻¹) | 250 | 52 | 51.3 | 51 | 30.5 | 28.2 |
| Melt Viscosity (Pa-s) at 1000 s⁻¹) | 157 | 42 | 31.4 | 30.7 | 18.7 | 44.8 |
| DTUL at 1.8 MPa (° C.) | 233 | 253 | 255 | 253 | 260 | 250 |
| Charpy Unnotched (kJ/m²) | 15 | 18 | 33 | 33 | 42 | 33 |
| Charpy Notched (kJ/m²) | 7 | 12 | 12 | 12 | 17 | 12 |
| Tensile Strength (MPa) | 185 | 148 | 182 | 181.06 | 189 | 173 |
| Tensile Modulus (MPa) | 35,297 | 32,344 | 32,583 | 32,300 | 30,260 | 31,053 |
| Tensile Elongation (%) | 0.71 | 0.58 | 0.82 | 0.81 | 0.97 | 0.82 |
| Flexural Strength (MPa) | 295 | 236 | 272 | 269 | 270 | 264 |
| Flexural Modulus (MPa) | 34,773 | 32,141 | 29,813 | 29,883 | 27,142 | 29,627 |
| Flexural Elongation (%) | 1.21 | 0.99 | 1.36 | 1.32 | 1.55 | 1.3 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A foldable electronic device comprising a housing that contains a first housing portion positioned on a first side of a bend axis and a second housing portion positioned on a second opposing side of the bend axis, wherein the first and second housing portions are coupled to a hinge for rotational motion about the bend axis, wherein the hinge comprises a polymer composition that contains a polymer matrix and a plurality of reinforcing fibers distributed within the polymer matrix, wherein the polymer composition exhibits a flexural modulus of about 15,000 MPa or more as determined in accordance with ISO 178:2019 at 23° C. and a melt viscosity of about 300 Pa-s or less as determined at a shear rate of 1000 s⁻¹ in accordance with ISO 11443:2021 at a temperature that is 15° C. higher than a melting temperature of the composition.

2. The foldable electronic device of claim 1, wherein the polymer composition exhibits a Charpy notched impact strength of about 5 kJ/m² or more as determined at a temperature of 23° C. in accordance with ISO 179-1:2010.

3. The foldable electronic device of claim 1, wherein the polymer composition has a melting temperature of about 250° C. or more.

4. The foldable electronic device of claim 1, wherein the polymer composition exhibits a tensile modulus of about 16,000 MPa or more as determined in accordance with ISO 527:2019 at a temperature of 23° C.

5. The foldable electronic device of claim 1, wherein the polymer composition exhibits a deflection temperature under load of about 180° C. or more as measured according to ISO 75-2:2013 at a specified load of 1.8 MPa.

6. The foldable electronic device of claim 1, wherein the polymer matrix contains a thermotropic liquid crystalline polymer.

7. The foldable electronic device of claim 6, wherein the polymer matrix contains a liquid crystalline polymer that contains repeating units derived from 4-hydroxybenzoic acid.

8. The foldable electronic device of claim 7, wherein the second liquid crystalline polymer further contains repeating units derived from 6-hydroxy-2-naphthoic acid.

9. The foldable electronic device of claim 8, wherein the liquid crystalline polymer contains units derived from 6-hydroxy-2-naphthoic acid in an amount from about 10 mol. % to about 40 mol. %.

10. The foldable electronic device of claim 7, wherein the liquid crystalline polymer further contains repeating units derived from terephthalic acid, isophthalic acid, hydroquinone, 4,4′-biphenol, or a combination thereof.

11. The foldable electronic device of claim 10, wherein the molar amount of 4,4′-biphenol is greater than the molar amount of hydroquinone and/or the molar amount of terephthalic acid is greater than the molar amount of isophthalic acid.

12. The foldable electronic device of claim 7, wherein thermotropic liquid crystalline polymers constitute from about 50 wt. % to about 95 wt. % of the polymer matrix.

13. The foldable electronic device of claim 1, wherein the reinforcing fibers include glass fibers.

14. The foldable electronic device of claim 1, wherein the reinforcing fibers include carbon fibers.

15. The foldable electronic device of claim 14, wherein the carbon fibers are recycled.

16. The foldable electronic device of claim 1, wherein the reinforcing fibers constitute from about 10 wt. % to about 70 wt. % of the composition.
